(19) United States
(12) Patent Application Publication
(10) Pub. No.: US 2007/0041593 A1
(43) Pub. Date: Feb. 22, 2007

(54) Audio on/off switching

(76) Inventor: John A. Marinovich, West Hills, CA (US)

Correspondence Address: LAW OFFICES OF DAVID L. HOFFMAN, 27023 MCBEAN PKWY, SUITE 422, VALENCIA, CA, 91355, US

(21) Appl. No.: 11/509,088

(22) Filed: Aug. 21, 2006

Related U.S. Application Data
(60) Provisional application No. 60/709,657, filed on Aug. 19, 2005.

(51) Int. Cl. H04R 3/00

(52) U.S. Cl. 381/122

(57) ABSTRACT

Provided are disabling and/or switching assemblies that disable a microphone when a singer or other user moves away from it. In certain implementations, the assembly utilizes a kill switch, such as a pressure-activated floor-pad switch or a proximity sensor. In another aspect, a switch assembly is provided, with the assembly including an input port for accepting a cable plug from an audio pickup device (e.g., a microphone, guitar pickup or other audio transducer), an output port and a foot-activated switch connected between the two. According to one variation, the foot-activated switch is configured to control multiple audio pickup devices. According to another, the foot-activated switch is a two-state on/off device that changes state each time it is adequately depressed and after such a depression does not change state until depressed again, thereby allowing a user to control one or more audio pickup devices largely irrespective of proximity.

### CROSS REFERENCE TO RELATED APPLICATION(S)

This application claims priority from U.S. Provisional Patent Application Ser. No. 60/709,657 filed Aug. 19, 2005, and which is incorporated by reference herein.

### BACKGROUND OF THE INVENTION

1. Field of the Invention

The present invention pertains to apparatuses for enabling and/or disabling an audio pickup device, e.g., an apparatus that cause a microphone to be disabled when a user moves away from it.

2. Description of the Related Art

Conventionally, when a music band is performing it often is desirable for the sound engineer to disable each microphone during periods when the singer or other musician is not using it. Disabling such microphones often can avoid feedback from other musicians. However, the present inventor has discovered that such a procedure often is cumbersome for the engineer to perform and sometimes it is neglected.

There have been attempts to fix the feed back problem by changing the circuitry. U.S. Pat. No. 6,246,864 to Koike discloses a method of cutting out feedback by filtering certain frequencies. These fixes are often complex and most likely require the user to buy an entirely new sound system.

It is apparent that there is a need for an inexpensive way, in particular for performances as well as other situations, to cut out feedback caused when the performer is finished with the microphone.

### SUMMARY OF THE INVENTION

The present invention addresses this problem, among others, by providing disabling and/or switching assemblies that disable a microphone when the singer or other user moves away from it. In certain implementations, the assembly utilizes a kill switch, such as a pressure-activated floor-pad switch or a proximity sensor. In another aspect of the invention, a switch assembly is provided, with the assembly including an input port for accepting a cable plug from an audio pickup device (e.g., a microphone, guitar pickup or other audio transducer), an output port and a foot-activated switch connected between the two. According to one variation, the foot-activated switch is a two-state on/off device that changes state each time it is adequately depressed and after such a depression does not change state until depressed again, thereby allowing a user to control one or more audio pickup devices largely irrespective of proximity.

The foregoing summary is intended merely to provide a brief description of the general nature of the invention. A more complete understanding of the invention can be obtained by referring to the claims and the following detailed description of the preferred embodiments in connection with the accompanying figures.

### BRIEF DESCRIPTION OF THE DRAWINGS

FIG. 1 is a representational side view showing an arrangement of a microphone, footpad switch and junction box according to a representative embodiment of the present invention.

FIG. 2 is a cross-sectional view of the footpad switch shown in FIG. 1.

FIG. 3 is a top plan view of an upper or lower plate assembly for a footpad switch according to an alternate embodiment of the invention.

FIG. 4 is a schematic diagram of the junction box shown in FIG. 1.

FIG. 5 is a representational view showing an arrangement of a microphone and footpad switch, without the use of a separate junction box, according to an alternate embodiment of the present invention.

FIG. 6 is a schematic view of the footpad switch shown in FIG. 5.

FIG. 7 is a representational view showing an arrangement of a microphone and a proximity sensor according to a representative embodiment of the present invention.

FIG. 8 is a representational view showing an arrangement of a plurality of microphones, a seat that includes a pressure-activated switch for controlling them and a junction box, according to a representative embodiment of the present invention.

FIG. 9 is a schematic view of the junction box shown in FIG. 8.

FIG. 10 is a representational view showing an arrangement of a plurality of microphones and a foot-activated switch for controlling them according to a representative embodiment of the present invention.

FIG. 11 is a schematic view of the foot-activated switch shown in FIG. 10.

FIG. 12 is a schematic diagram of an alternative junction box to the one shown in FIG. 4.

FIG. 13 is a schematic diagram of a wireless version of the junction box shown in FIG. 4

### DESCRIPTION OF THE PREFERRED EMBODIMENT(S)

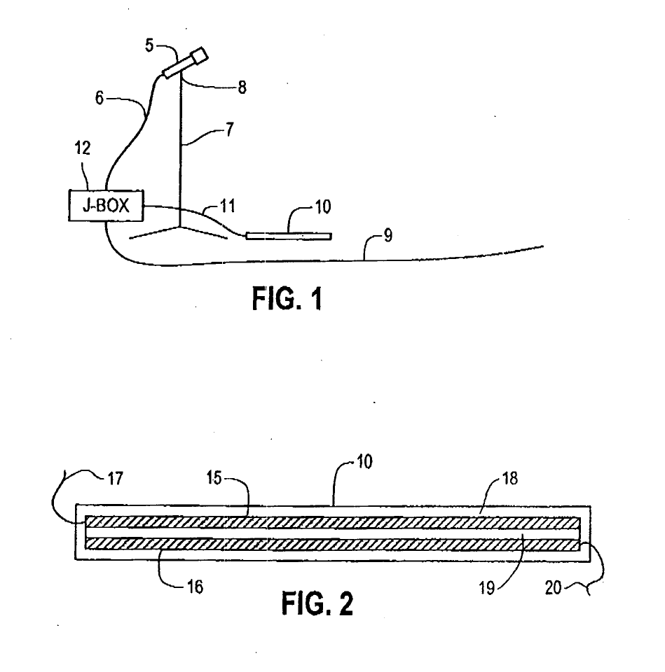

FIG. 1 shows a microphone 5 supported by a stand 7 (collectively, microphone assembly 8), a footpad switch 10 and a junction box 12 according to a first embodiment of the present invention. Microphone 5 points rearwardly and footpad switch 10 is disposed on the floor immediately behind microphone 5. As a result, when a user approaches microphone 5 to sing or speak into it, the user will step onto pad 10. In this way, footpad switch 10 functions as a proximity sensor with respect to microphone 5.

Preferably, footpad switch 10 is rectangular in shape when viewed from the top and is sized large enough to cover the entire area in which a user might stand when using microphone 5 (e.g., at least two or three feet wide by two or three feet long). The size preferably depends upon the pickup range and cord range of microphone 5. In other embodiments, footpad switch 10 is circular, oval or any other desired shape. In addition, footpad switch 10 preferably is fairly flat, i.e., no thicker than necessary, in order to reduce the likelihood of accidental tripping. For similar reasons, the periphery (or at least a portion thereof) of footpad switch 10 preferably tapers to a reduced thickness at its extreme outer edge (although it is shown with an abrupt drop-off in the drawings).

Cable 6 from microphone 5 attaches to junction box 12, as does cable 11 from footpad switch 10. Output cable 9 from box 12 preferably attaches to a mixing board (not shown). This generally is the case for all of the embodiments discussed below. That is, the output cable from the applicable switch or separate junction box (if such a separate junction box is used) typically will attach to a mixing board. However, in certain embodiments of the invention the output cable attaches directly to an amplifier and/or recording device.

FIG. 2 is a cross-sectional view of footpad switch 10. In the current embodiment of the invention, footpad switch 10 is comprised of a resilient upper metal plate 15 and a lower metal plate 16, surrounded by an insulation layer 18. A gap 19 between plates 15 and 16 prevents electrical current from flowing from one plate to the other in the normal state. However, once adequate weight or pressure is applied, upper plate 15 deforms downwardly, contacting plate 16 and thereby closing the switch. When the weight or pressure subsequently is removed, plate 15 springs back to a flat orientation (e.g., at least approximately parallel to plate 16), thereby reopening the switch. A lead 17 connects to upper plate 15 while a lead 20 connects to lower plate 16. Leads 17 and 20 permit switch 10 to connect to other devices, as described in more detail below. In certain embodiments, both leads 17 and 20 attach to a plug (not shown in the drawings) for easily connecting to and disconnecting from such external devices.

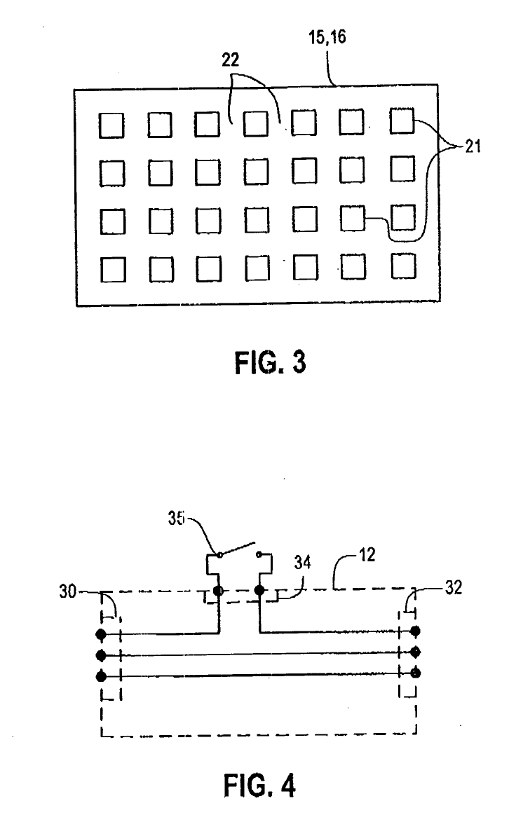

It should be noted that rather than using a single conductive upper plate 15 and a single conductive lower plate 15, in alternate embodiments multiple upper conductive elements (e.g., all commonly connected) are included in either or both plates 15 and 16. An example is shown in FIG. 3, in which conductive electrical contacts 21 are separated by portions 22 that can be used to insert a supporting structure between plates 15 and 16 (i.e., partially filling gap 19). As a result of such a structure, larger footpad switches generally will be possible than can be achieved with a pair of parallel contiguous metal plates separated solely by an air gap 19.

In another embodiment, gap 19 is filled with a solid resilient dielectric material that supports upper plate 15. In such an embodiment, a depression of plate 15 will not necessarily result in a direct electrical contact between plates 15 and 16, but will change the capacitance of footpad switch 10. Upon detection of a sufficient change in capacitance (using alternating-current circuitry), an electronic switch is closed. Upon the detection of a subsequent sufficient opposite change in capacitance (corresponding to the removal of pressure from plate 15), the electronic switch is once again opened.

FIG. 4 is a schematic view of junction box 12, according to a representative embodiment of the invention. As shown, junction box 12 has an input port 30 and an output port 32, each having three connectors (or pins) such as hot, ground and neutral, as well as a port 34 for an external switch 35. Preferably, input port 30 is an ordinary microphone input jack and output port 32 is a corresponding microphone output jack, such as an XLR or RSL connector jack. It should be noted that in other embodiments of the invention, the input and output ports may include any other number of connectors.

Each connector for input port 30 is electrically coupled to a corresponding connector in output port 32. However, as shown in FIG. 4, at least one of such couplings is through external switch 35 (via port 34), thereby providing an interrupt in the audio signal so that switch 35 is open. In the current embodiment of the invention, the switch 35 causes the neutral line to open when the user moves away from microphone 5. While such a configuration currently is preferred, as it may result in reduced switching noise and other benefits, the techniques of the present invention may be used to interrupt any of the other lines necessary for an output audio signal from microphone 5.

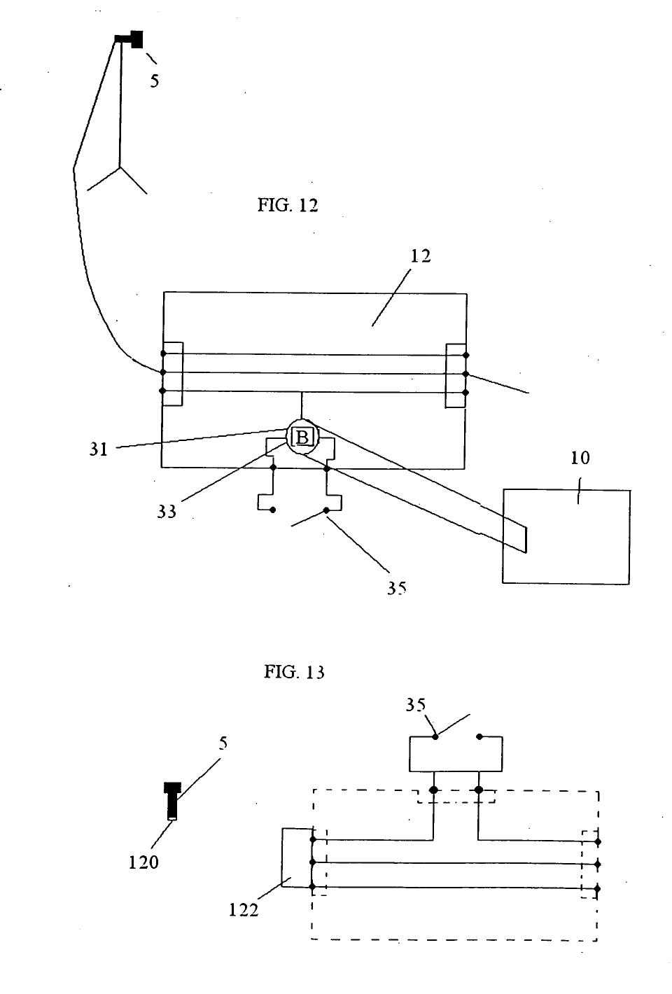

The audio signal can be set up to go through the pad 10 so that when the pad is stepped on the circuit is closed and the audio signal is on. When the pad 10 is not stepped on (the plates 15 and 16 are not in contact), the audio signal cannot pass. However, the junction box circuitry can also be set up so that the audio signal goes through a switch controlled by a relay, (like relay 95 in FIG. 9). In such a case, when the pad is stepped on, that signals the relay to close the circuit. The advantage to this structure is that the contacts in the pad and wires do not need to be sufficient quality to carry an audio signal. Moreover, with such a structure, when the user steps off of the pad there can be a delay using a buffer or timer to prevent the signal from being cut off right away. This prevents pauses in the audio if the user accidentally or intentionally steps off the pad only temporarily. In such an embodiment, seen in FIG. 12, junction box 12 includes a relay 31 and a buffer or times circuit 33. When the user steps on the pad 10 the plates 15 and 16 make contact and a signal is sent to the relay 31 which closes the switch 35. When the user steps off of the pad 10 the circuit does not open immediately due to the buffer or timer circuit 33. The circuit 33, which could simply be a timer, keeps the switch 35 closed for a predetermined amount of time (e.g. one half of a second to a second). After the predetermined amount of time the circuit will open. This will effectively prevent disturbances in the audio if the user accidentally or intentionally steps off the pad 10 temporarily.

In the current embodiment of the invention, external switch 35 is footpad switch 10. However, it instead might be any of the other switches described herein or any other conventional switch, whether entirely mechanical, entirely electronic or any combination of the two. In that regard, junction box 12 (or any of the other junction boxes described herein) preferably includes ancillary electronics for facilitating the operation of external switch 35 (e.g., capacitance detection/switching circuitry with respect to the embodiment described above in which switch 10 merely changes capacitance when depressed, or supporting electronics for the proximity sensors described below).

Also, it should be noted that either or both of ports 30 and 32 may be mounted into the chassis of junction box 12 (as illustrated) or in alternate embodiments may be attached to a cable that extends from junction box 12.

In another embodiment the microphone 5 used could be wireless as seen in FIG. 13. The microphone 5 would have a wireless transmitter 120. Either inside the junction box 12 or in a separate housing attached the junction box, as shown in FIG. 13, there is a wireless receiver 122 that receives the signal from transmitter 120. The same method could be used for the pad 10. A first transmitter on the pad could send a signal when it is stepped on to close the switch 35. The signal would be received by a first receiver on or inside the junction box. A second transmitter could transmit a second signal that would be received by a second receiver on or in the junction box to tell the switch 35 to open when the user moves off the pad.

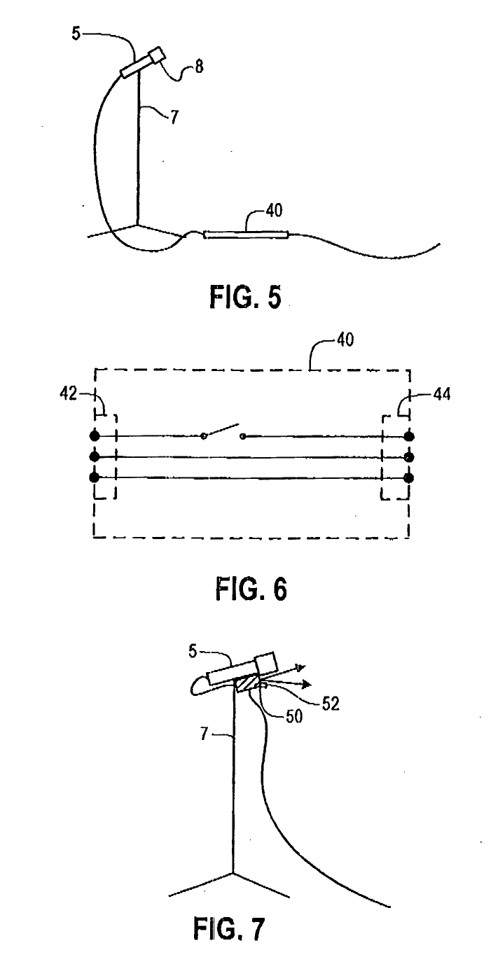

The foregoing embodiment of the invention has the advantage that conventional footpad switches may be used for switch 10, with the addition of an easily designed and constructed junction box 12. FIGS. 5 and 6 illustrate a somewhat modified embodiment in which a footpad switch 40 is specially manufactured to include the wiring connections provided in junction box 12 in the previous embodiment, thereby avoiding the need for a separate junction box. Thus, input port 42 preferably is an ordinary microphone input jack and output port 44 preferably is a corresponding microphone output jack.

FIG. 7 illustrates a further embodiment of the invention in which the proximity switch (a pressure-activated switch in other embodiments) is a proximity sensor 50 (i.e., a receiver-based or transceiver-based device for detecting when an object is within the detection range). In the preferred embodiment, sensor 50 is mounted directly underneath (or in any event, on or in close proximity to) microphone 5. The sensor detects when an object approaches within close proximity to it and, accordingly, is close to microphone 5. Sensor 50 may be implemented, e.g., as an infrared, laser, optical or ultrasound sensor. Upon detection, i.e., when an object meeting the switching criteria (e.g., regarding the appropriate combination of size and proximity) the switch closes, activating microphone 5. When the switching criteria are not satisfied, i.e., the sensor 50 is not triggered, the switch opens, disabling microphone 5. The actual switch may be integrated with sensor 50 or may be provided as a separate electronic switching circuit. Moreover, a separate junction box (e.g., box 12) may be utilized or sensor 50 may be implemented as a self-contained switch, such as shown in FIG. 6.

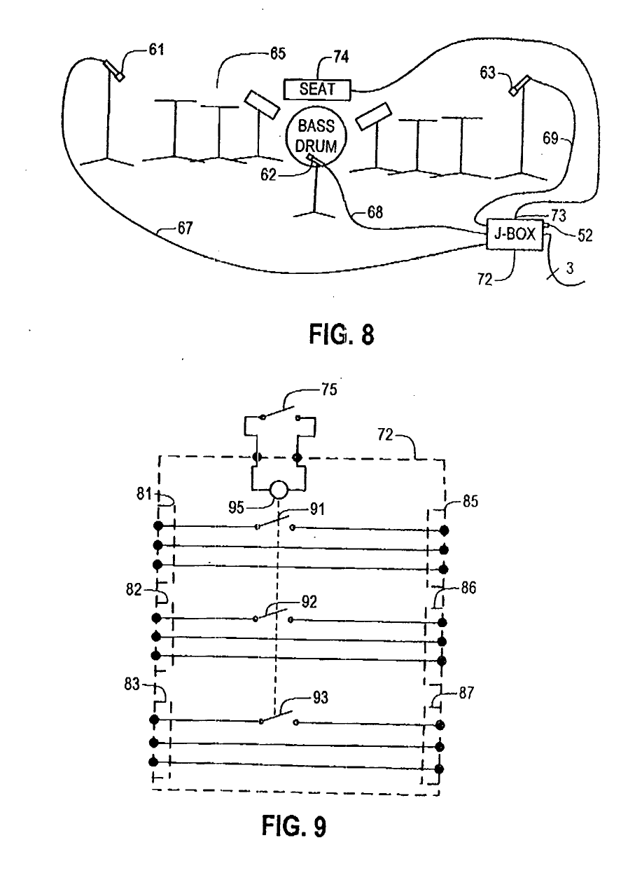

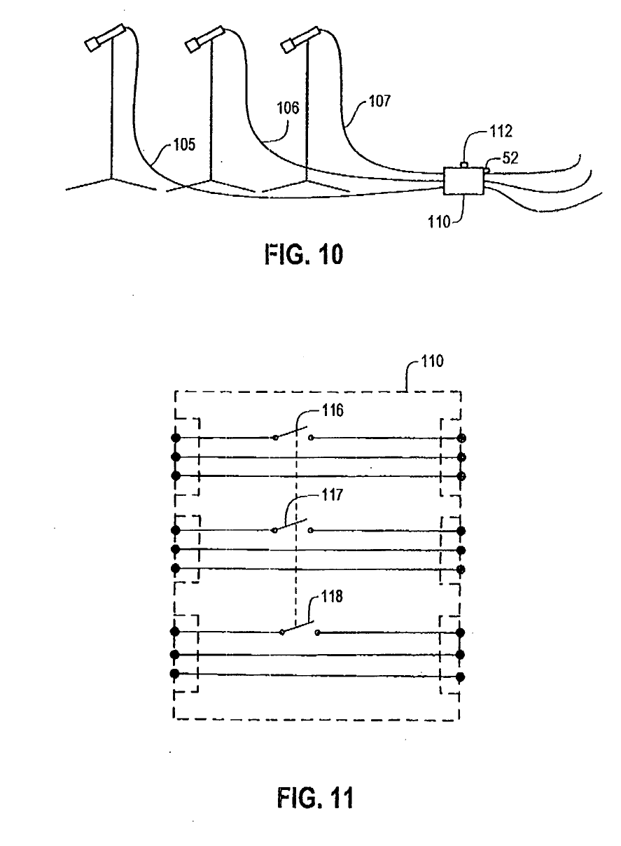

In any event, the switching circuitry preferably is provided with a light-emitting diode (LED) or other indicator light 52 which illuminates when the switch is closed (i.e., the microphone is activated). Such an indicator light can be used for adjustment purposes only (e.g., setting the sensitivity of the proximity sensor 50) or also could be used in actual operation so that the user knows with certainty when the microphone is activated. It is noted that a similar indicator light 52 can be used in connection with the embodiments employing a pressure-activated floor-pad switch, although in such embodiments the user often will be able to feel when he or she has stepped onto the pad. In such embodiments, the indicator light 52 preferably is disposed on the junction box, e.g., junction box 72 (shown in FIG. 8) or junction box 110 (shown in FIG. 10).

Preferably, the sensitivity of proximity sensor 50 is adjusted so as to turn on the microphone when a user is within the pickup range of the microphone and to turn it off when user is outside of such pickup range. Different ranges might be used for such purposes. For instance, the device might be configured to turn the microphone on when a user is within approximately four inches of the microphone and to keep it on until the user moves more than twelve inches away from the microphone. It would be evident to one of ordinary skill in the art as to how to construct an appropriate structure and/or circuitry to achieve a turning on response to close proximity and then a cutting off response to a greater, predetermined distance that would also be responsive to the size of the object it is sensing.

FIGS. 8-11 illustrate alternate embodiments in which multiple microphones are switched (e.g., turned on and off) simultaneously. In the first such embodiment, illustrated in FIG. 8, a user controls a plurality of microphones 61-63 that are configured so as to pick up sound from different positions located proximate to a drum set 65. The corresponding microphone cables 67-69 plug into a junction box 72, as does the cable from a seat-mounted pressure-activated switch that is attached to seat 74.

FIG. 9 is a schematic diagram of junction box 72. Similar to junction box 12, junction box 72 also has a port 73 for, or is otherwise hardwire-connected to, an external switch. In this case, switch 75 (which is the pressure-activated switch mounted in seat 74) is used. In addition, in contrast to previous embodiments, in the present embodiment junction box 72 has multiple input ports (e.g., three input ports 81-83 in this specific embodiment) and corresponding output ports (e.g., output ports 85-87 in this embodiment). Once again, each input port connector is electrically coupled (e.g., by appropriate wiring) to a corresponding connector on the output port. However, in the through corresponding switches 91-93. Such switches 91-93, in turn, simultaneously are controlled (e.g., opened and closed by external switch 75 via activation circuit 95. Accordingly, switches 91-93 may be mechanical switches, as would be the case if activation circuit 95 is the activation coil of a mechanical relay with current through activation circuit 95 being controlled by external switch 75. Alternatively, switches 91-93 may be electronic switches (e.g., transistors) whose activation voltage or current is controlled by external switch 75 via activation circuitry 95.

In the embodiment shown in FIG. 10, cables 105-107 from multiple microphones are fed into a junction box 110 which also includes a two-state pushbutton switch 112 for simultaneously enabling or disabling microphones 105-107. Switch 112 initially is open and then closes when adequate pressure is applied. Switch 112 then remains closed until adequate pressure is removed to effect a transition back to the open (or off) state. As shown in FIG. 11, junction box 110 includes three separate internal switches 116-118, each controlling at least one signal of the corresponding microphone cable. Accordingly, switches 116-118 may be configured, e.g., as the second stages of a mechanical relay or as commonly controlled electronic switches. Alternatively, because switch 112 is included within junction box 110, switches 116-118 may be implemented as the individual connectors of switch 112.

Finally, it should be noted that a two-state switch also could be utilized in any of the embodiments described above for controlling a single microphone. Basically, such a switch permits the microphone to be activated and/or deactivated at will, without maintaining a constant proximity to the microphone(s), thus allowing for override of the proximity sensor or pressure sensor.

Additional Considerations.

In the embodiments described above, the various connections typically are described and shown as connector ports, thereby providing increased modularity. However, each such connection may be made using a detachable connector or may be hardwired, e.g., using solder.

Simple switches are referenced above and shown in the accompanying drawings. However, depending on the devices to which such switches attach, as well as the nature of the switches themselves, in certain cases it will be desirable to incorporate, e.g., an in-line resistor (such as a 1000-ohm resistor) or a low-pass circuit to eliminate any clicking or hissing noise when the switch opens or closes.

Also, in the embodiments discussed above microphones are switched on and off. However, it should be noted that the present invention contemplates the switching of other audio pickup devices as well. One exemplary embodiment involves the switching of the signal from a guitar audio pickup, in which the junction box or switch attaches to such a pickup instead of (or in addition to) a microphone.

Generally speaking, two examples of switches are described in the embodiments above: a normally open switch and a two-state pushbutton switch. In alternate embodiments, however, it often will be desirable to use a normally closed (e.g., spring biased pushbutton or pad-type) switch. A normally closed switch is particularly desirable in situations where the microphone or other audio pickup device normally is on and the user sometimes wants to temporarily disable it. One specific example is in a courtroom where a judge and/or the parties want to have a sidebar conversation. In such a case, the judge or party simply presses the button or pad (e.g., using his or her foot), thereby temporarily disabling the microphone, and then releases pressure when the conversation is again intended for the open court. Such a normally closed switch can be substituted into any of the embodiments described above.

It is further noted that the terms “normally open” and “normally closed”, as used herein, are intended to refer to the effect that the overall switching circuit has on the microphone or other audio pickup signal. Thus, for example, a normally open physical switch (such as the pad switch 10) easily can be converted into a normally closed switching circuit with the addition of a relay or electronic switch (e.g., incorporated into junction box 12).

Finally, all of the embodiments discussed above utilize hardwired cable connections between the various system components. However, it should be understood that in alternate embodiments of the invention some or all of such hardwired connections are replaced by wireless links.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in come cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

What is claimed is:

1. An audio switching assembly, comprising:
(a) a microphone; and
(b) a kill switch electrically coupled to the microphone and configured so as to automatically disable the microphone when a user moves away from the microphone.

2. An audio switching assembly according to claim 1, wherein the kill switch comprises a pressure-activated floor-pad switch.

3. An audio switching assembly according to claim 1, wherein the microphone is supported by a structure that ultimately rests on the floor, such that the microphone points rearwardly, and wherein the kill switch is disposed on the floor immediately behind the microphone.

4. An audio switching assembly according to claim 1, wherein the kill switch comprises a proximity sensor.

5. An audio switching assembly according to claim 4, wherein the proximity sensor comprise at least one of an infrared, a laser, a photoelectric or an ultrasound sensor.

6. An audio switching assembly according to claim 4, wherein the proximity sensor comprises an indicator light that indicates when the microphone is enabled.

7. An audio switching assembly according to claim 1, wherein the kill switch is normally a normally open switch that is in series with a neutral like of the microphone.

8. An audio switching assembly, comprising:
(a) a microphone; and
(b) disabling means for determining when a user moves away from the microphone and, in response to such determination, automatically disabling the microphone.

9. An audio switching assembly according to claim 8, wherein the disabling means comprises a pressure-activated floor-pad switch.

10. An audio switching assembly according to claim 8, wherein the microphone is supported by a structure that ultimately rests on the floor, such that the microphone points rearwardly, and wherein the disabling means is disposed on the floor immediately behind the microphone.

11. An audio switching assembly according to claim 8, wherein the disabling means comprises a proximity sensor.

12. An audio switching assembly according to claim 11, wherein the proximity sensor comprises at least one of a photoelectric, a laser, an infrared or an ultrasound sensor.

13. An audio switching assembly according to claim 11, wherein the proximity sensor comprises an indicator light that indicates when the microphone is enabled.

14. An audio switching assembly according to claim 8, wherein the disabling means is a normally open switch that is in series with a neutral line of the microphone.

15. An audio switching assembly, comprising:
(a) an input port for accepting a cable plug from an audio pickup device;
(b) an output port;
(c) conductors electrically coupling connectors on the input port to corresponding connectors on the output port; and
(d) a foot-activated switch configured to interrupt a signal on at least one of the conductors.

16. An audio switching assembly according to claim 15, wherein the switch is activated by downward pressure.

17. An audio switching assembly according to claim 16, wherein the switch comprises a two-state on/off device that changes state each time it is adequately depressed and after such a depression does not change state until depressed again.

18. An audio switching assembly according to claim 15, wherein the input port and the output port are enclosed in a first chassis, and wherein the switch is enclosed in a second chassis that it is physically separate from the first chassis.

19. An audio switching assembly according to claim 15, further comprising a second input port for accepting a second audio pickup device cable plug and a corresponding second output port, and wherein the switch simultaneously interrupts a signal on the audio pickup device cable plug and second audio pickup device cable plug.

20. An audio switching assembly according to claim 15, wherein the switch is configured to interrupt a neutral line of the audio pickup device.

21. An audio switching assembly according to claim 15, wherein the audio pickup device comprises at least one of a microphone or a guitar pickup.
